(19) United States
(12) Patent Application Publication
(10) Pub. No.: US 2026/0240717 A1
(43) Pub. Date: Aug. 20, 2026

(54) WIRELESS-ENABLED SEX TOY

(71) Applicant: SISU IP Holding LLC, LANTANA, FL (US)

(72) Inventors: Mya L Johnson, Lantana, FL (US); Lana Eitel, Lantana, FL (US)

(73) Assignee: SISU IP Holding LLC, LANTANA, FL (US)

(21) Appl. No.: 19/327,749

(22) Filed: Sep. 12, 2025

Related U.S. Application Data
(60) Provisional application No. 63/693,795, filed on Sep. 12, 2024.

(51) Int. Cl. A61H 19/00; A61H 23/02; G10L 13/02; G10L 15/18

(52) U.S. Cl. CPC A61H 19/44; A61H 23/02; G10L 13/02; G10L 15/18; A61H 2201/0207; A61H 2201/501

(57) ABSTRACT

A system and method for providing an AI-enabled sex toy having a large language model (LLM) for generating an auditory response to user input signal utilizes a sexual stimulation device having a sex toy elongated body and an inner cavity. The inner cavity encloses a wireless transmitter-receiver, a heating element, a vibration generator, a microphone, a speaker, and an electronic controller circuitry. The electronic controller circuity includes an audio circuitry, a charging circuit, a rechargeable battery, a wireless modem, a data storage device, and a query digital processor. The query digital processor generating an auditory response to user input using an LLM data model.

### RELATED APPLICATIONS

The application claims priority to United States Provisional Patent Application Number 63/693,795, entitled “AI-Based Wireless-Enabled Sex Toy,” filed on 12 Sep. 2024, Attorney Docket No. GIPL1051.001-US-P01, U.S. Patent Application, entitled “AI-Based Wireless-Enabled Sex Doll,” Ser. No., 63/693,800. filed on 12 Sep. 2024 Attorney Docket No. GIPL1051.001-US-P02, and U.S. Patent Application, entitled “AI-Based Wireless-Enabled Sex Board Game,” Ser. No., 63/693,802, filed on 12 Sep. 2024, Attorney Docket No. GIPL1051.001-US-P03.

The instant patent application is related to a concurrently owned and filed U.S. Patent Application, entitled “AI-Based Wireless-Enabled Sex Toy Board Game,” Ser. No., ??/???, ???. filed on 12 Sep. 2025, Attorney Docket No. GIPL 1051.001-US-03, and U.S. Patent Application, entitled “AI-Based Wireless-Enabled Sex Doll,” Ser. No., ??/???, ???, filed on 12 Sep. 2025, Attorney Docket No. GIPL 1051.001-US-02. The above applications are incorporated herein as if they are recited in their entirety.

### TECHNICAL FIELD

This application relates in general to a system and method for providing an artificial intelligence (AI)-based wireless-enabled sex toy, and more specifically, to a system and method for providing a sex toy having audio music interactive user instructions, and guidance.

### BACKGROUND

Sex toys are a large business market used by individuals and couples as part of intimate sexual activity. Individuals and couples may currently receive sex-related advice from various sources including doctors and medical information sources, advice columns and media programs such as ones provided by Dr. Ruth, books, articles, videos media programs, and similar sources. This information may be accessed in print form and/or from online sources such as web pages, webcasts, podcasts, YouTube® videos and channels, and similar information sources.

While individuals and couples may be able to find relevant information upon completion of various search processes, this search activity is not conducive to being part of the sexual activity of individuals in which needed information is identified. Currently, individuals and couples must stop their activities, perform a search to identify useful information, consume the information in its available format, and then resume their intimate activities. The time and effort needed to perform these steps make the real-time retrieval and utilization of the information impractical.

Therefore, a need exists for an AI-based search function within the AI-based wireless-enabled sex toy, so individuals and couples can quickly request information and receive relevant responses quickly and without a significant interruption to their activity. The AI-based search function may learn over time the preferences and limitations of individuals to tailor responses to meet the needs of unique individuals.

### SUMMARY

In accordance with the present invention, the above and other problems are solved by providing a system and method for providing an AI-based wireless-enabled sex toy according to the principles and example embodiments disclosed herein.

In one embodiment, the present invention is a system for providing an AI-enabled sex toy having a large language model (LLM) for generating an auditory response to user input signals utilizing a sexual stimulation device having a sex toy elongated body and an inner cavity. The inner cavity encloses a wireless transmitter-receiver, a heating element, a vibration generator, a microphone, a speaker, and an electronic controller circuitry. The electronic controller circuity includes an audio circuitry, a charging circuit, a rechargeable battery, a wireless modem, a data storage device, and a query digital processor. The query digital processor generating an auditory response to user input using an LLM data model.

Another aspect of the system further includes the query digital processor controlling the operation of the heating element and the vibration generator.

Another aspect of the system further includes the query digital processor receiving user input signal from the audio circuitry and generating the user response using an LLM digital processor and the LLM data model to be transformed into the auditory response by the audio circuitry.

Another aspect of the system further includes the LLM digital processor and the LLM data model hosted within the sexual stimulation device.

Another aspect of the system further includes the LLM digital processor and the LLM data model hosted in a remote server.

Another aspect of the system further includes the auditory response includes one or more of the following auditory data types: a streaming music recording, sound effects, auditory sounds to enhance the mood, health, and wellness advice to provide appropriate and helpful answers to questions, recommend additional activities to improve their intimacy during these activities, synthetic human speech data corresponding to the responsive results generated by the LLM processor, and Voice-over-IP (VoIP) connection data.

Another aspect of the system further includes the sexual stimulation device further comprising a sex toy removable bottom cover coupled to a bottom surface of the sex toy elongated body enclosing the inner cavity, the sex toy removable bottom cover has an audio output screen.

Another aspect of the system further includes the electronic controller circuity further comprises a voice recognition component and a voice generation component.

Another aspect of the system further includes the query digital processor receiving auditory data content from a remote content server, the auditory data content includes one or more of the following: the streaming music recording, the sound effects, and the auditory sounds to enhance the mood.

Another aspect of the system further includes the query digital processor communicates with remote servers utilizing a mobile communications device.

In another embodiment, the present invention In one embodiment, the present invention is a method for providing an AI-enabled sex toy having a large language model (LLM) for generating an auditory response to user input signal utilizing a sexual stimulation device having a sex toy elongated body and an inner cavity. The method receives a user input signal from a microphone, recognizes a voice input command within the user input signal, transmits the voice input command to an LLM processor, generates a response to the voice input command by the LLM processor utilizing an LLM data model, generates an auditory response from the response generated within the LLM processor, generates a human voice representation of the auditory response, and outputs the human voice representation of the auditory response utilizing a speaker.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrates an example embodiment for external components of an article of manufacture providing an AI-based wireless-enabled sex toy according to the present invention.

FIGS. 2a-c illustrates additional example embodiments of an article of manufacture providing an AI-based wireless-enabled sex toy according to the present invention.

FIG. 3 illustrates a plurality of software components implementing an AI-based wireless-enabled sex toy according to the present invention.

FIG. 4 illustrates a generalized schematic of a programmable processing system utilized as the various computing components described herein used to implement an embodiment of the present invention.

FIG. 5 illustrates a set of software components executable in a programable computing device implementing an AI-enabled wireless-enabled sex toy according to the present invention.

FIG. 6 illustrates a flowchart of a sequence of operations performed by a programmable digital processor in implementing a method of providing a wireless-enabled sex toy according to the present invention.

### DETAILED DESCRIPTION

This application relates in general a system and method for providing additional sensory stimulation, and more specifically, to a system and method for providing olfactory sensory stimulation according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps or components. It also should be noted that in some alternative implementations, the functions and acts noted may occur out of the order noted in the figures. For example, two figures shown in succession may be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a media player, set-top box, smartphone, tablet, and/or web browser on any computing device.

The terms “partners,” “individuals,” and “user” refer to an entity, e.g. a human, using a wireless-enabled sex toy including any software or smart device application(s) associated with the invention. The terms user, partner, and individual herein refer to one or more humans.

The term “connection” refers to connecting any component as defined below by any means, including but not limited to, a wired connection(s) using any type of wire or cable for example, including but not limited to, coaxial cable(s), fiber optic cable(s), ethernet cable(s) or wireless connection(s) using any type of frequency/frequencies or radio wave(s). Some examples are included below in this application.

The term “invention” or “present invention” refers to the invention being applied for via the patent application with the title “Wireless-Enabled Sex Tot.” Invention may be used interchangeably with sex toy.

The term “sex toy” refers to an electronic sexual stimulation device for use by individuals and partners while engaging in sexual activity, including obtaining assistance and advice, suggestions, and gameplay.

The terms “communicate”, or “communication” refer to any component(s) connecting with any other component(s) in any combination for the purpose of the connected components to communicate and/or transfer data to and from any components and/or control any settings.

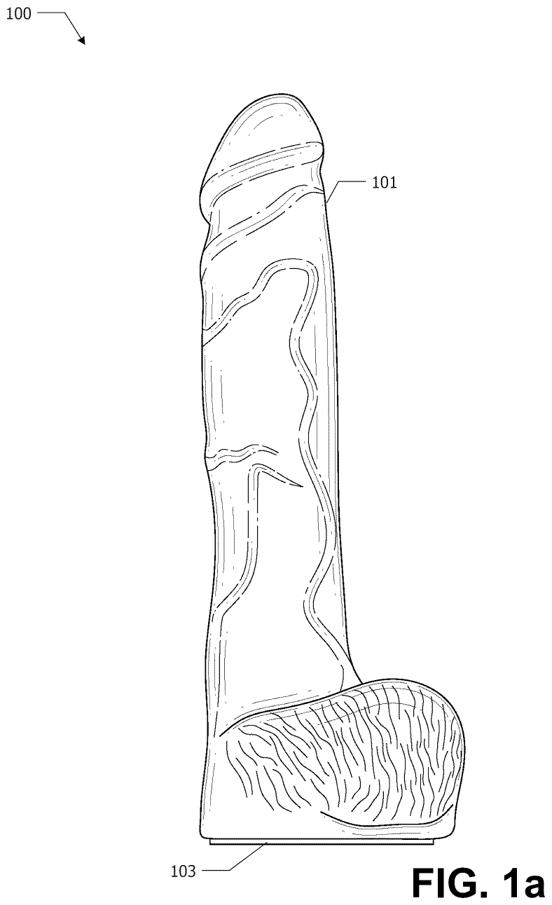

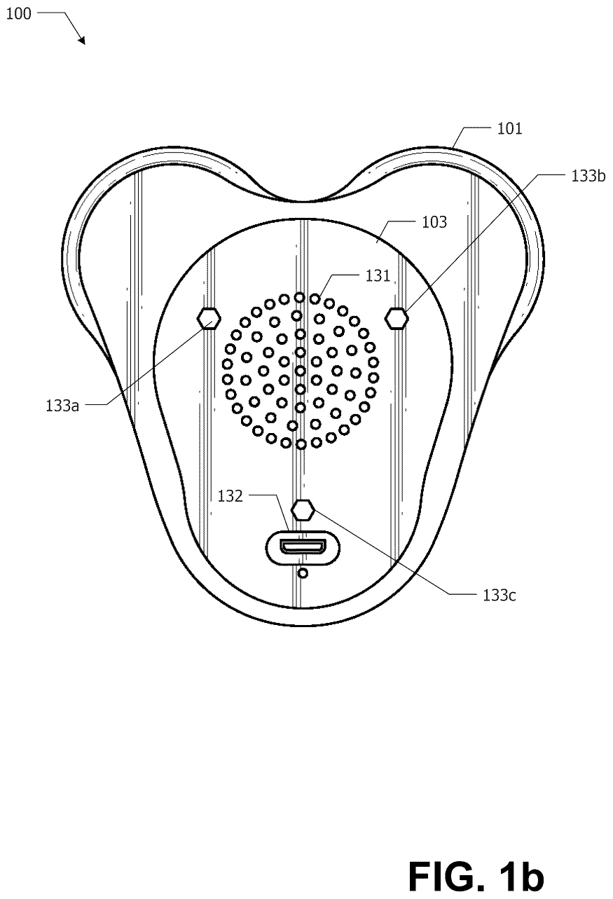

In general, the present disclosure relates a system and method for providing wireless-enabled sex toy according to the present invention. To better understand the present invention, FIGS. 1a-b illustrates an example embodiment of a system that provides wireless-enabled sex toy according to the present invention. FIG. 1a shows an example embodiment of a wireless-enabled sex toy having audio music and interactive user instructions and guidance. The wireless-enabled sex toy elongated body 101 includes an inner cavity of the wireless-enabled sex toy elongated body 101 for storing an electronic controller circuitry 202 and related components.

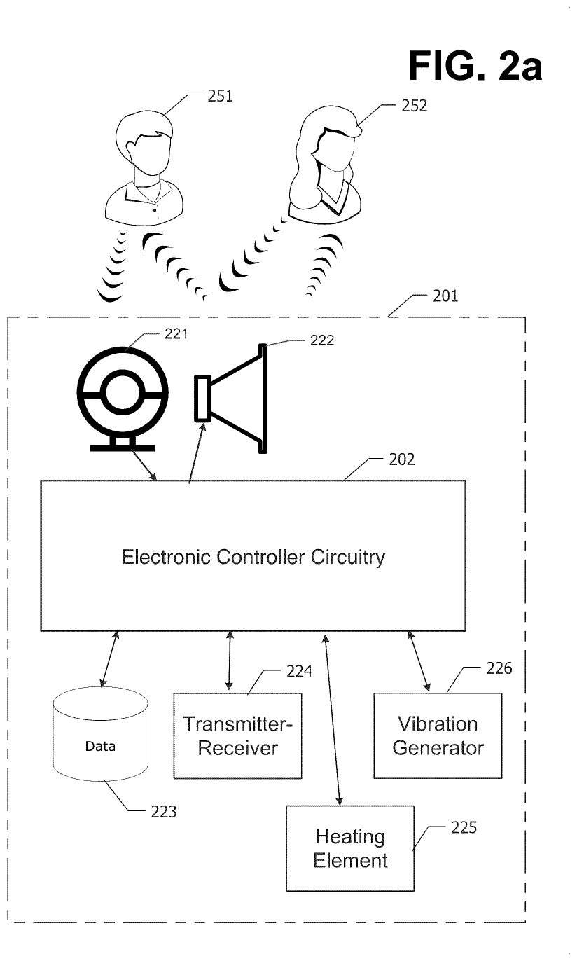

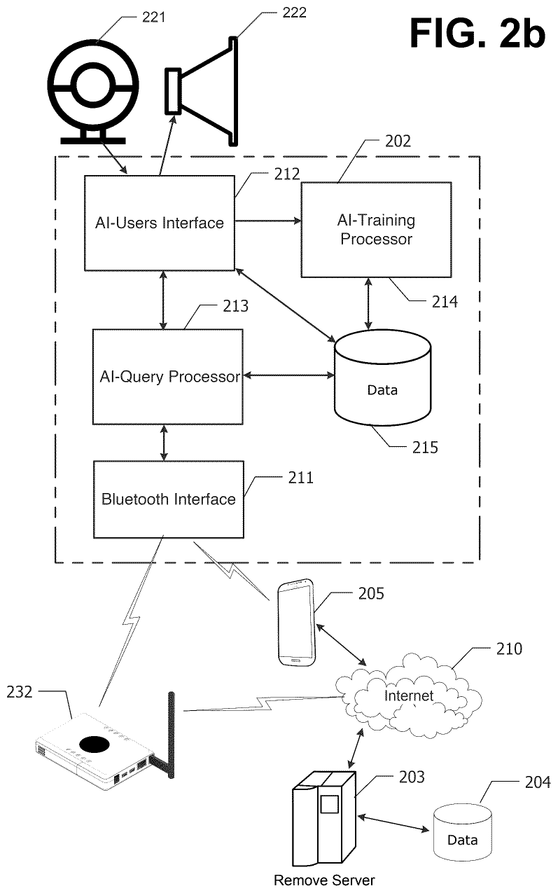

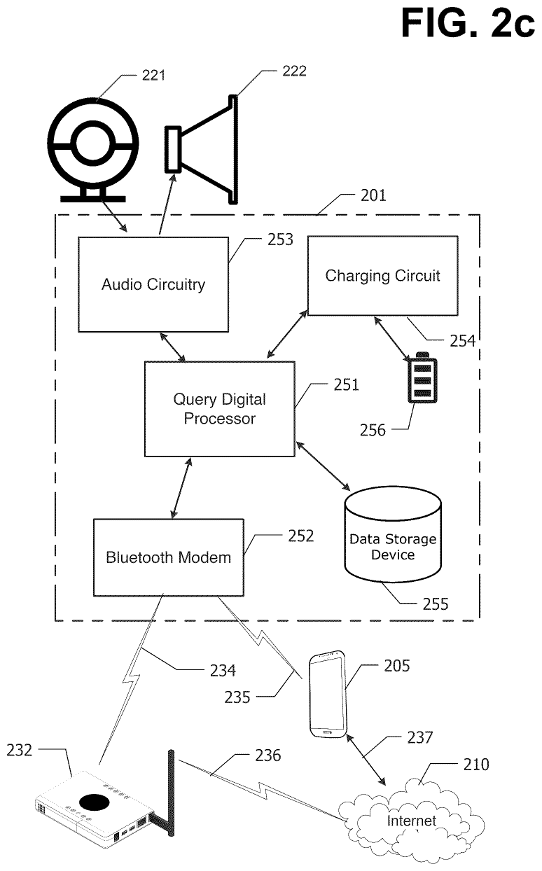

FIG. 1b shows a wireless-enabled sex toy removable bottom cover 103 enclosing the inner cavity of the wireless-enabled sex toy elongated body 101. The wireless-enabled sex toy 100 utilizes an electronic controller circuitry 202 to implement the AI-based wireless-enabled sex toy 201 as disclosed in more detail about FIGS. 2a-c. The electronic controller circuitry 202 receives auditory commands from partners 261-262 for operating the wireless-enabled sex toy 100. The electronic controller circuitry 202 also generates audio output as part of the operation of the wireless-enabled sex toy 100. The auditory input and output pass into and out of the audio output screen 131 within the wireless-enabled sex toy elongated body 101 through the wireless-enabled sex toy removable bottom cover 103 secured by coupling devices 133a-c such a screws. The wireless-enabled sex toy removable bottom cover 103 also includes a charging port 132 for connecting an external power source to charge a battery rechargeable battery 256 (shown in FIG. 2c) within the wireless-enabled sex toy 100. In one embodiment, the charging port 132 may utilize a USB-C type connector that accepts a USB-C charging cable (not shown). One of ordinary skill will recognize that other USB-type connectors or similar connectors, such as the Apple ® Lighting™ connector. The partners 261-262 may use the wireless-enabled sex toy 100 while the wireless-enabled sex toy 100 receives auditory commands and generates the audio output.

The wireless-enabled sex toy 100 uses electronic controller circuitry 202 within the wireless-enabled sex toy elongated body 101 to implement an artificial intelligence (AI)-based large language model (LLM) to process the received auditory commands and to generate the audio output. For example, in one embodiment of an LLM may include GPT-04, Chat GPT, and similar models. The AI-based LLM is used to respond to questions from the partners 261-262 in the received auditory commands to provide health information, sexual activity suggestions, music, partner voices, and all related functions disclosed herein.

FIGS. 2a-c illustrates additional example embodiments of an article of manufacture providing a wireless-enabled sex toy according to the present invention. FIG. 2a shows an AI-based wireless-enabled sex toy 201 having an electronic controller circuitry 202, a microphone 221, a speaker 222, a local data storage 223, a transmitter-receiver 224, a vibration generator 226, and a heating element 225. One or more partners 261-262 utilize the AI-based wireless-enabled sex toy 201 by providing auditory input commands and receiving auditory response data generated by the electronic controller circuitry 202.

The electronic controller circuitry 202 processes all received auditory data and commands and generates the response provided to the partners 261-262. The components within the electronic controller circuitry 202 include hardware components disclosed in reference to FIG. 2c, and software components disclosed in reference to FIG. 2b.

The microphone 221 receives auditory signals passing through the audio output screen 131 in the wireless-enabled sex toy removable bottom cover 103. The partners 261-262 may speak about the wireless-enabled sex toy 100 while in use to command the wireless-enabled sex toy 100 as desired.

The Speaker 222 generates auditory signals passing through the audio output screen 131 in the wireless-enabled sex toy removable bottom cover 103. The partners 261-262 can hear these auditory signals while utilizing the wireless-enabled sex toy 100.

The local data storage 223 provides data storage for use in processing commands and generating responses within the electronic controller circuitry 202. The local data storage 223 may store AI-related data associated with an LLM and any of the processing components including the speech recognition, synthesized speech generation, and the sound effects supported by the electronic controller circuitry 202. The wireless network modem 223 also may store data associated with the operation of other components within the wireless-enabled sex toy 100 including the transmitter-receiver 224, the vibration generator 226, and the 226.

The heating element 225 may be included within the electronic controller circuitry 202 and the wireless-enabled sex toy elongated body 101. The heating element 225 generates heat to warm the outer surface of the wireless-enabled sex toy elongated body 101 making use of the wireless-enabled sex toy 100 more pleasurable. The heating element 225 may be controlled by the processor in the electronic controller circuitry 202 in response to voice commands and/or heating commands from the mobile communications device 205 and other computing devices. The heating element 225 also may be controlled using input buttons or switches located on the wireless-enabled sex toy elongated body 101 and/or wireless-enabled sex toy removable bottom cover 103 that directly enable the heating element 225 to operate.

The vibration generator 226 may be included within the electronic controller circuitry 202 and the wireless-enabled sex toy elongated body 101. The vibration generator 226 generates vibrations within the wireless-enabled sex toy elongated body 101 to simulate the movement of the outer surface of the wireless-enabled sex toy elongated body 101 making use of the wireless-enabled sex toy 100 more pleasurable. The vibration generator 226 may be controlled by the processor in the electronic controller circuitry 202 in response to voice commands and/or heating commands from the mobile computing device 205 and other computing devices. The vibration generator 226 also may be controlled using input buttons or switches located on the wireless-enabled sex toy elongated body 101 and/or wireless-enabled sex toy removable bottom cover 103 that directly enable the vibration generator 226 to operate.

FIG. 2b shows circuitry components within the electronic controller circuitry 202 that includes a Bluetooth™ interface 211, an AI-user interface 212, an AI-query processor 213, an AI-training processor 214, and a LLM data storage 215. The Bluetooth™ interface 211 communicates with a network access point 232 over wireless the Bluetooth™ communications connection 234 and communicates with a mobile computing device 205 such as a smartphone, tablet, or personal computer over a wireless local area network communications connection 237. The mobile computing device 205 and the network access point 232 may connect with the remote server 203 over the Internet 210 to access remote data content 204 accessible by the remote server 203. While the disclosed embodiments utilize Bluetooth™ and WIFI connections 236-237 to access the Internet 210, the AI-based wireless-enabled sex toy 201 may communicate with these devices using any wireless communications channel and wireless data protocol.

The AI-user interface 212 corresponds to a software component to receive auditory signals from the microphone 221, converting the signals into digital data that may be sent to the AI-query processor 213 for processing. The AI-user interface 212 also outputs auditory signals corresponding to sounds of all types generated within the electronic controller circuitry electronic controller circuitry 202. The AI-user interface 212 receives the output auditory data as a digital signal and converts a sequence of data into auditory signals output by the speaker 222.

The AI-query processor 213 corresponds to a set of software components that receive data and commands to control the operation of the AI-based wireless-enabled sex toy 201 when in use. The AI-query processor 213 processes the received data and commands using a large language model (LLM) that supports the functions to be performed using the data. The AI-query processor 213 may utilize one or more LLMs relevantly trained to provide corresponding functions. For example, the sexual and wellness LLM used to generate responses to commands and related data may be separate from a voice synthesizing LLM used to cause the responses to these commands sound like one or more of the partners 261-262 and disclosed herein.

The AI-training processor 214 generates one or more LLMs utilized by the AI-query processor 213 using training input data. The training input data may comprise continuous training data obtained while the AI-based wireless-enabled sex toy 201 is in use as well as a finite-sized training data set created to generate the corresponding LLMs. In a preferred embodiment, the training input data includes peer-reviewed medical and scientific research data relating to medical, psychological, and sexual health from professionally recognized research organizations. The medical and scientific research data may be publicly published articles, reports, and data sets generated by the professionally recognized research organizations. The professionally recognized research organizations may include the National Institutes of Health, WebMd, the Mayo Clinic, Johns Hopkins University, Johns Hopkins Medical School and Hospital, and similar medical institutions.

The digital data storage 215 includes digital data used by the LLM processors when operating the AI-based wireless-enabled sex toy 201. The digital data may be organized into a database, file storage hierarchy, or similar data structure to allow efficient operation of the AI-query processor 213 and AI-training processor 214.

FIG. 2c shows a set of electronic components included within the electronic controller circuitry 202 including a programmable data processor 251, a Bluetooth^{TH} modem 252, audio circuitry 253, charging circuitry 254, a rechargeable battery 256, and a data storage device 255. The programmable data processor 251 receives and processes a user input signal from input-output interface. The programmable data processor 251 may also receive input signals from the audio circuitry 253. The programmable data processor 251 may generate a response. The programmable data processor 251 may control the operation of the vibration generator and heating elements using the vibration generator 226 and the heating element heating element 225.

The Bluetooth^{TH} modem 252 sends and receives electromagnetic signals to create a digital communications channel between the electronic controller circuitry 202 and the network access point 232. The Bluetooth^{TH} modem 252 receives digital data from the programmable data processor 251 that is to be communicated to a remote device, such as the mobile computing device 205 and remote server 203 using a protocol. The Bluetooth^{TH} modem 252 also may utilize other wireless communication channels and protocols consistent with the utilization disclosed herein.

The audio circuitry 253 connects the microphone 221 and speaker 222 to the electronic controller circuitry 202 and its components while converting the auditory signals to and from digital data representations.

The charging circuitry 254 receives input electrical voltage from the charging port 132 to charge the rechargeable battery 256. The charging circuitry 254 connects the input electrical voltage to the rechargeable battery 256 for recharging. The charging circuitry 254 also monitors the voltage within the rechargeable battery 256 while in use and also when recharging to provide an indication of the amount of electrical charge within the rechargeable battery 256. The charging circuitry 254 also may disconnect the input electrical voltage from the rechargeable battery 256 when the rechargeable battery 256 has been recharged to a maximum storage level and prolong the usable life of the rechargeable battery 256.

The rechargeable battery 256 is an electrical charge storage device used to provide power to the electronic controller circuitry 202 and all electrically powered components within the AI-based wireless-enabled sex toy 201.

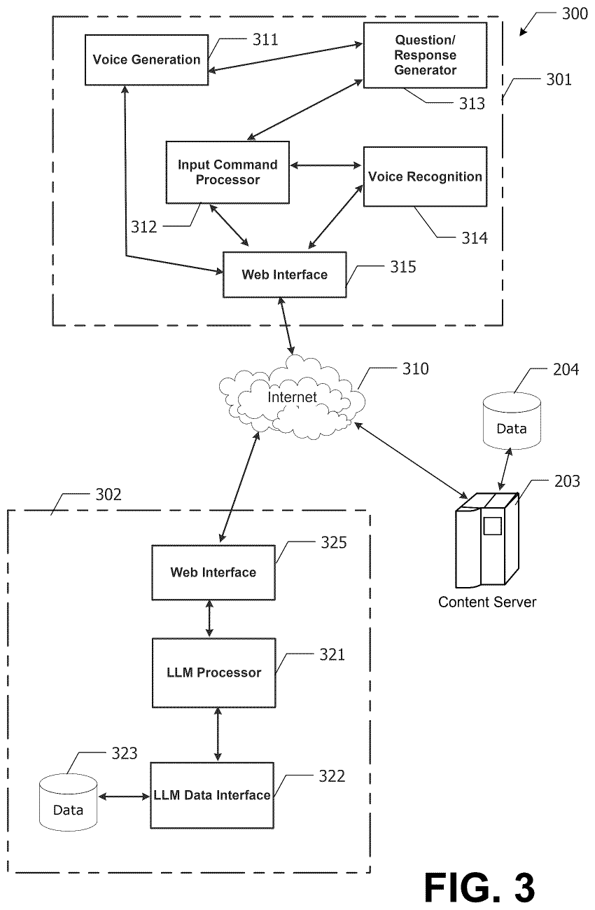

The data storage device 255 is a digital data storage device such as a disk drive, solid-state storage device, and similar electrical devices. The data storage device 255 stores the digital data and LLM data 323 shown in FIG. 3 below as well as all other data used to operate the digital hardware and software components in the AI-based wireless-enabled sex toy 201.

For example, one embodiment, the electronic controller circuitry 202 may respond to commands and input questions to determine health and wellness advice to provide appropriate and helpful answers to questions from the partners 261-262. The electronic controller circuitry 202 also may respond with suggestions on additional activity to enhance the partners'activities and may generate additional sounds including music and sound effects to improve the mood of individuals using the wireless-enabled sex toy 100.

In another embodiment, the electronic controller circuitry 202 may include an AI-based search device to enhance intimacy between the partners 261-262 during various activities. The AI-based wireless-enabled sex toy 100 may receive auditory input commands to determine and recommend additional activities that the partners 261-262 may wish to engage to improve their intimacy during these activities, the electronic controller circuitry 202 may perform speech recognition to generate input commands for the electronic controller circuitry 202 for use in identifying and providing specific actions for the partners 261-262. The electronic controller circuitry 202 may also receive non-verbal auditory data that may be used to identify the individual partners' 261-262 current actions. These actions may then be used to determine if additional actions by one or more of the partners 261-262 would enhance their interaction and intimacy and provide the additional actions using generated speech expressing these additional actions.

Similarly, the partners 261-262 may ask auditory questions to the electronic controller circuitry 202 to generate any recommended activity that may correspond to the questions input by the partners 261-262. As above, the auditory questions may be processed using speech recognition processing to generate input data suitable for consumption and use by the electronic controller circuitry 202 in generating responses. As noted above, the electronic controller circuitry 202 may over time learn the preferences of the partners 261-262 as well as preferred activities that are more successful in enhancing the interaction between the partners 261-262 when generating responses.

In yet another embodiment, the electronic controller circuitry 202 generates synthetic human speech data corresponding to the responsive results generated by the AI-based wireless-enabled sex toy 201. The voice generation may translate the response into one or more s corresponding to the preferences of the partners 261-262. One or more of the partners 261-262 also may provide commands to the electronic controller circuitry 202 that instructs a specific one or more languages to be used in providing the responsive data.

Additionally, the voice generated by the electronic controller circuitry 202 also may correspond to a synthesized representation of the voice of one of the partners 261-262. One or more of the partners 261-262 may provide sample voice data to the electronic controller circuitry 202 that is input into the AI-based large language model (LLM) used to generate the synthesized voice data. This sample voice data may be used to train the LLM to enable the generated voice data to correspond to the voice of the partner 261-262. Once trained, the LLM usage enables one of the partners 261-262 to interact with the synthesized voice of the other partner during times when the partner is not present and unavailable to participate in the activity.

In an alternate embodiment, the AI-based wireless-enabled sex toy 201 may communicate with remote individuals using a voice call, a Voice-over-IP (VoIP) connection, or a similar video call to permit the partners 261-262 to interact with each other while one of the partners uses the AI-based wireless-enabled sex toy 201. The AI-based wireless-enabled sex toy 201 may connect to a mobile computing device 205 as disclosed herein in reference to FIGS. 2a-c below. The mobile computing device 205 may be used to connect the partners 261-262 to each other using a voice and/or video call while their respective voices may provide input and commands to the electronic controller circuitry 202 as otherwise disclosed herein. Similarly, the electronic controller circuitry 202 may include an application that provides a VoIP connection to a remote computing device such as a mobile phone, tablet, or computer. Once the connection is established, the partners 261-262 may interact with the AI-based wireless-enabled sex toy 201 as disclosed herein.

In other embodiments, the electronic controller circuitry 202 may output music, sound effects, and similar auditory sounds to enhance the mood of the partners 261-262 while they interact with each other and use the AI-based wireless-enabled sex toy 201. The music output by the electronic controller circuitry 202 may include digitally encoded music stored within the electronic controller circuitry 202. Alternatively, the electronic controller circuitry 202 may connect to remote computing devices to request and receive streaming data from remote services and data sources.

The electronic controller circuitry 202 also may generate sound effects requested by one of the partners 261-262 using voice commands. For example, one of the partners may request the generation of barking like a dog while the AI-based wireless-enabled sex toy 201 is in use. The electronic controller circuitry 202 may retrieve and generate auditory data corresponding to a barking dog that is output to the users. The sound effects may correspond to any auditory data in which the LLM has been trained.

FIG. 3 illustrates a plurality of software components implementing a wireless-enabled sex toy according to the present invention. A set of software components 300 is shown with software components 301 executing within the wireless-enabled sex toy 100 and software components 302 executing in a LLM processing device 203. In this embodiment, the device software component 301 in the wireless-enabled sex toy 100 provides user interface functions to receive commands and generate responses from results generated in an LLM. The LLM software components 302 in the LLM processing device 203 implement the AI functionality of the LLM. The software components 301 include a voice generator 311, an input command processor 312, a question-response generator 313, a voice recognition component 314, and a web interface 315. The software components 302 include an LLM processor 321, an LLM data interface 322, an LLM database and data storage 323, and a server web interface 325.

In a preferred embodiment, the device software components 301 and LLM software components 302 may be executed within a system on a chip processor in the electronic controller circuitry 202 depending upon the processing capabilities of the processor in the wireless-enabled sex toy 100. In alternate embodiments, the LLM software components may be performed within a remote server. The system-on-a-chip may include a multi-core processor having onboard memory, peripheral device support including wireless communications supporting various wireless protocol such as WIFI and Bluetooth®. Example devices include an ESP32S3 processor from Espressif Systems, a Snapdragon® process from Qualcomm, ® an ARM-based processor from multiple manufacturers, and NUC® processors from Intel®.

The voice generator 311 generates voice data used to generate output auditory signals converted from a digital to analog form to be applied to the speaker 222. The voice generator 311 may receive responses in a text-readable format that is translated into sound using a digital-to-analog converter (not shown). The voice generator 311 also may generate voice data corresponding to a response generated using the LLM processor 321 using a first LLM database 323 corresponding to the sound of a voice of one or more of the partners 261-262 that has been previously trained to this voice. This generation of the output auditory signals in a particular user's voice may be performed within the LLM processor 321 using a second LLM database 323.

The input command processor 312 processes input commands from the voice recognition component 314 to generate an LLM command to be sent to the LLM processor 321. The input command processor 312 creates the LLM commands and related data to be sent for use in generating a response using an LLM database. The input command processor 312 sends the LLM commands and data to the web interface 315 for transmission over the Internet 210.

The question-response generator 313 generates an auditory response from the response generated within the LLM processor and an LLM data model. The auditory response includes one or more of the following auditory data type: a streaming music recording, sound effects, auditory sounds to enhance the mood, health and wellness advice to provide appropriate and helpful answers to questions, recommend additional activities to improve their intimacy during these activities, synthetic human speech data corresponding to the responsive results generated by the LLM processor, and Voice-over-IP (VoIP) connection data.

The voice recognition component 314 generates input commands from the input auditory signals received from the microphone 221. The voice recognition component 314 receives voice data used to generate input auditory signals converted from an analog to digital form received from the microphone 221. The input commands may be sent to the LLM processor 321 for further processing to generate a response.

The web interface 315 enables the electronic controller circuitry 202 to communicate with remote devices, for example, the remote server 203, using an Internet transport and security protocol. The web interface 315 performs all data format translations needed to generate and receive TCP/IP data over the Internet 210.

The LLM processor 321 processes received input data from one or more of the software components 301-302 using an LLM database 323 trained to respond to the data within a command or query. The LLM processor 321 performs all computations associated with applying input data to an LLM database to generate an appropriate response.

The LLM data interface 322 provides a data access and storage operation associated with accessing data within an LLM database. The LLM data interface 322 performs all of the operations necessary to interact with the LLM database, to address data contained within the LLM database, store data into the LLM database, and all database indexing and maintenance processing to enable accessing data in the LLM database quickly and efficient. The LLM data interface 322 also provides security functions to enable access to the LLM database by one or more of the partners 261-262.

The LLM database and data storage 323 implements a database engine and state storage component to enable the storage and access of LLM data within the LLM database. The LLM database and data storage 323 performs all data formatting and accuracy processing needed to retrieve and store data in the LLM database. The LLM database includes a LLM data model that is created by training the LLM data model with a predefined training data set. The predefined training data set contains know data to be relied upon when user queries are submitted by a user to generate a response. The LLM data model may be updated over time as additional trusted data is identified. The LLM data model may be updated dynamically when user submits documents and related data for inclusion within the LLM data model. The LLM data model may also be updated based upon user responses to previously generated queries that indicate a particular user preference.

In the preferred embodiment, the training input data includes peer-reviewed medical and scientific research data relating to medical, psychological, and sexual health from professionally recognized research organizations. The medical and scientific research data may be publicly published articles, reports, and data sets generated by the professionally recognized research organizations. The professionally recognized research organizations may include the National Institutes of Health, WebMd, the Mayo Clinic, Johns Hopkins University, Johns Hopkins Medical School and Hospital, and similar medical institutions.

The server web interface 325 enables the remote server 203 to communicate with a remote device, for example, the electronic controller circuitry 202, using an Internet transport and security protocol. The server web interface 325 performs all data format translations needed to generate and receive TCP/IP data over the Internet 210.

In various embodiments, the LLM database, LLM processor, and LLM processing tasks may be executing instructions and software components in one or more computing systems otherwise disclosed herein. The LLM processing may be hosted remotely in a cloud server as well as being hosted within the wireless-enabled sex toy 100 and electronic controller circuitry 202 contained therein.

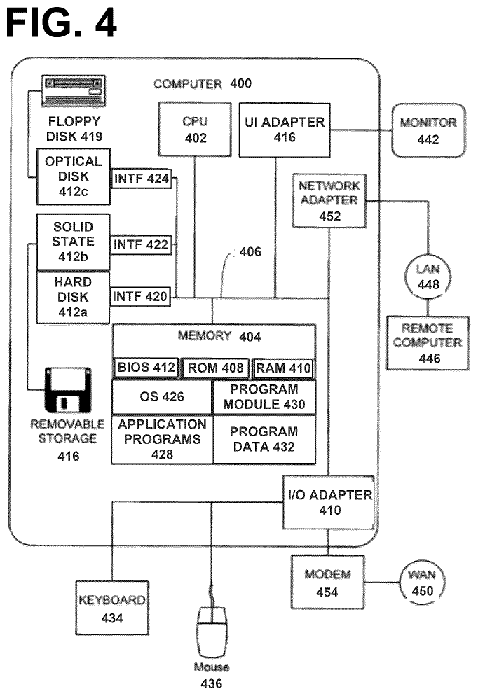

FIG. 4 illustrates a generalized schematic of a programmable processing system utilized as the various computing components described herein used to implement an embodiment of the present invention. The electronic controller circuitry 202 may be implemented as a digital processing system 400 that contains software in the form of executable instructions stored within the memory of the 202. When the CPU 402 executes these instructions in memory causing the AI-based wireless-enabled sex toy 201 to perform the functions of the wirelessly-enabled sex toy 100 as described herein. The digital processing system 400 may also correspond to digital computing devices including wireless network modem 223, mobile computing device 205, and remote server 203.

The CPU 402 is coupled to the system bus 404. The CPU 402 may be a general-purpose CPU or microprocessor, graphics processing unit (“GPU”), and/or microcontroller. The present embodiments are not restricted by the architecture of the CPU 402 so long as the CPU 402, whether directly or indirectly, supports the operations as described herein. The CPU 402 may execute the various logical instructions according to the present embodiments.

The computer system 400 also may include random access memory (RAM) 408, which may be synchronous RAM (SRAM), dynamic RAM (DRAM), synchronous dynamic RAM (SDRAM), or the like. The computer system 400 may utilize RAM 410 to store the various data structures used by a software application. The computer system 400 may also include read-only memory (ROM) 406 which may be PROM, EPROM, EEPROM, optical storage, or the like. The ROM may store configuration information for booting the computer system 400. The RAM 410 and the ROM 406 hold user and system data, and both the RAM 410 and the ROM 406 may be randomly accessed.

The computer system 400 may also include an input/output (I/O) adapter 410, a communications adapter 414, and a user interface adapter 416. The I/O adapter 410 and/or the user interface adapter 416 may, in certain embodiments, enable a user to interact with the computer system 400. In a further embodiment, the display adapter 422 may display a graphical user interface (GUI) associated with an operating system 426, program modules 430, application programs 428, and program data 432 included in software or web-based application to be shown on a display device 424, such as a monitor or touch screen.

The I/O adapter 410 may couple one or more storage devices 412a-c, such as one or more of a hard drive 412a, a solid-state storage device 412b, a flash drive, a compact disc (CD) drive 412c, a floppy disk drive 419, and a tape drive, to the computer system 400. According to one embodiment, the data storage 412 may be a separate server coupled to the computer system 400 through a network connection to the I/O adapter 410. The communications adapter 414 may be adapted to couple the computer system 400 to the network 408, which may be one or more of a LAN, WAN, and/or the Internet. The communications adapter 414 may also be adapted to couple the computer system 400 to other networks such as a global positioning system (GPS) or a Bluetooth network. The user interface adapter 416 couples user input devices, such as a keyboard 420, a pointing device 418, and/or a touch screen (not shown) to the computer system 400. The keyboard 420 may be an on-screen keyboard displayed on a touch panel. Additional devices (not shown) such as a camera, microphone, video camera, accelerometer, compass, and or gyroscope may be coupled to the user interface adapter 416. The display adapter 422 may be driven by the CPU 402 to control the display on the display device 424. Any of the devices 402-422 may be physical and/or logical.

The applications of the present disclosure are not limited to the architecture of computer system 400. Rather the computer system 400 is provided as an example of one type of computing device that may be adapted to perform the functions of a parking management system, including servers, personal computers, and mobile devices as shown in FIGS. 2a-c. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, or other circuitry. In fact, persons of ordinary skill in the art may utilize any number of suitable structures capable of executing logical operations according to the described embodiments. For example, the programmable data processor 251, remote server 203, and mobile computing device 205 may be virtualized for access by multiple users and/or applications.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

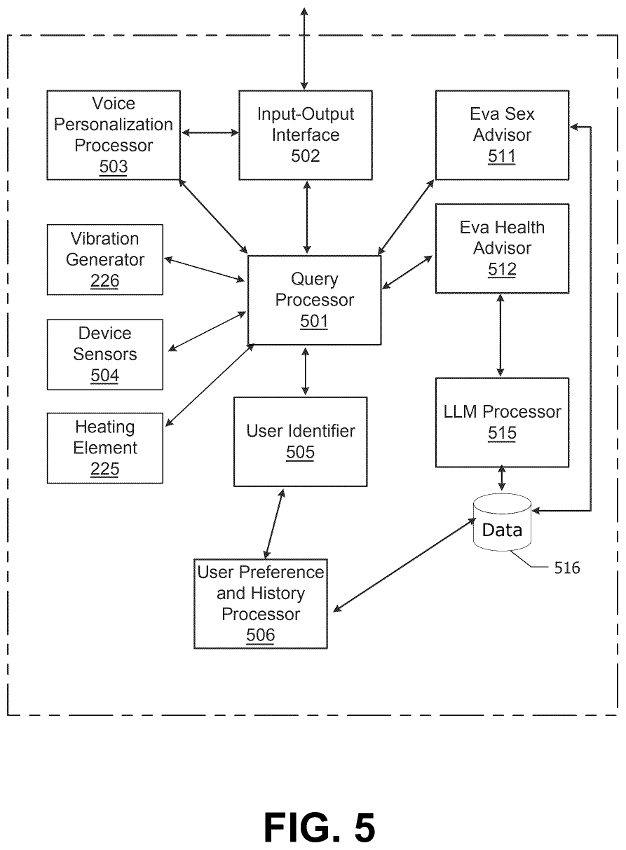

FIG. 5 illustrates a set of software components executable in a programable computing device implementing an AI-enabled wireless-enabled sex toy according to the present invention. The set of software components 500 include a query processor 501, an input-output interface 502, a voice personalization processor 503, device sensors 504, user identifier 505, a user preference and history processor 506, a sex advisor processor 511, a health advisor 512, an LLM processor 515 and an LLM data model 516, a vibration generation controller 526, and a heating element controller 525.

The query processor 501 receives and processes a user input signal from input-output interface. The query processor 501 may also receive input signals from the device sensors 504. The query processor 501 may communicate with the user preference and history processor 506, the sex advisor processor 511, the health advisor 512, and the LLM processor 515 and an LLM data model 516 to generate a response. The query processor 501 may control the operation of the vibration generator and heating elements using the vibration generation controller 526 and the heating element controller 525.

The input-output interface 502 provides input and output processing to provide a query processor 501 input commands and associated data needed to response generation as needed. The input-output interface 502 also formats and generates auditory output associated with the generated response to be sent to users and partners.

The voice personalization processor 503 receives the generated response and generates a synthetic voice representation of the generated response in a selected representative voice. The selected representative voice may correspond to a default voice in either gender or a representation of a particular individual voice trained and saved for use by particular users. The voice personalization processor 503 may use the user preference and history processor 506 to select the selected representative voice.

The device sensors 504 receives sensor input signals and formats them into a corresponding digital data format useful to perform processing by various software components 501-503 and 526-526.

The user identifier 505 processes auditory input data to identify a user and partners currently using the wireless-enabled sex toy 100 to obtain user preference and history data for use by various software components 501-504 and 511-517 when performing the corresponding functions in processing input commands and data to generate a response.

The user preference and history processor 506 maintains user preference data associated with user who have previously used the wireless-enabled sex toy 100. The user preference data corresponds to control parameters associated with the sex advisor processor 511, the health advisor 512, and the LLM processor 515 and LLM data model 516 used to generate a response corresponding to the preferences of the particular user. The user preference and history processor 506 may also update the user preference data based upon activities and inputs detected during use of the wireless-enabled sex toy 100 by a particular user.

The sex advisor processor 511 processes input queries from users in which a sexual activity, mood, and gaming activity question or issue is detected. The sex advisor processor 511 utilizes the LLM processor 515 and LLM data model 516 to generate an accurate and appropriate response to the input health question or issue.

The health advisor 512 processes input queries from users in which a health question or issue is detected. The health advisor 512 utilizes the LLM processor 515 and LLM data model 516 to generate an accurate and appropriate response to the input health question or issue.

The LLM processor 515 and LLM data model 516 processes received input data from one or more of the software components 501-106 using an LLM database 323 trained to respond to the data within a command or query. The LLM processor 515 performs all computations associated with applying input data to an LLM database 516 to generate an appropriate response.

The vibration generation controller 526 controls the operation of the vibration generator 226 to provide an operating state about detectable vibration within the wireless-enabled sex toy elongated body 101 when in use. The vibration generation controller 526 may receive signal data from the device sensors 504 to determine the operating state of the wireless-enabled sex toy elongated body 101 as compared to a selected vibration setting.

The heating element controller 525 controls the operation of the heating element 225 to provide a selected temperature about the wireless-enabled sex toy elongated body 101 when in use. The heating element controller 525 may receive signal data from the device sensors 504 to determine a current temperature to be compared with a selected temperature.

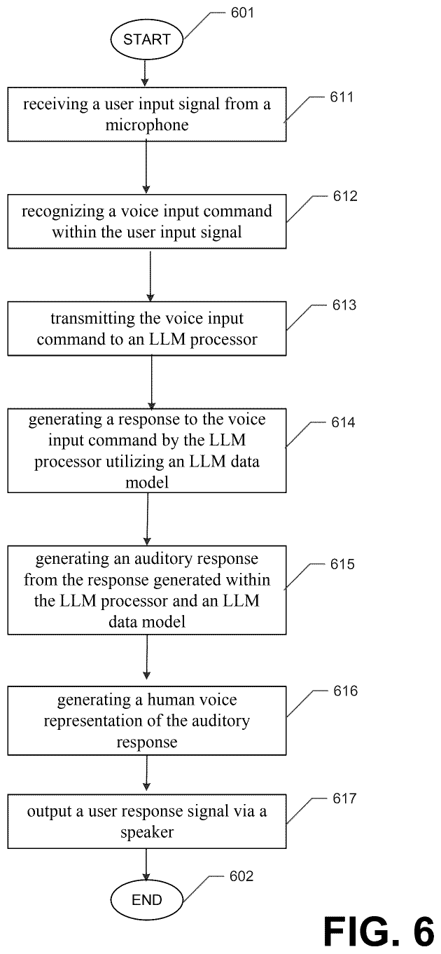

FIG. 6 is a flowchart of a sequence of operations performed by a programmable digital processor in implementing a method of providing a wireless-enabled sex toy according to the present invention.

The method begins 601 and receives a user input signal from a microphone in step 611. Next, the voice input command is recognized within the user input signal in step 612. The voice input command in step 613 is transmitted to an LLM processor;

In step 614, a response to the voice input command ins generated by the LLM processor utilizing an LLM data model. An auditory response is generated from the response generated within the LLM processor and an LLM data model in step 615.

A human voice representation of the auditory response is generated in step 616. The human voice representation of the auditory response is outputted in step 617 utilizing a speaker and the method ends 602.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing an AI-enabled sex toy having a large language model (LLM) for generating an auditory response to a user input signal, the system comprising:
a sexual stimulation device having a sex toy elongated body and an inner cavity, the inner cavity encloses:
a wireless transmitter-receiver;
a heating element;
a vibration generator;
a microphone;
a speaker; and
an electronic controller circuitry comprising:
an audio circuitry;
a charging circuit;
a rechargeable battery;
a wireless modem;
a data storage device; and
a query processor, the query processor generating an auditory response to a user input using an LLM data model.

2. The system according to claim 1, wherein the query processor controls operation of the heating element and the vibration generator.

3. The system according to claim 1, wherein the query processor receives user input signal from the audio circuitry and generates a user response using an LLM processor and the LLM data model to be transformed into the auditory response by the audio circuitry.

4. The system according to claim 3, wherein the LLM processor and the LLM data model are hosted within the sexual stimulation device.

5. The system according to claim 3, wherein the LLM processor and the LLM data model are hosted in a remote server.

6. The system according to claim 3, wherein the auditory response includes one or more of a following auditory data type: a streaming music recording, sound effects, auditory sounds to enhance a mood, health and wellness advice to provide appropriate and helpful answers to questions, recommend additional activities to improve their intimacy during these activities, synthetic human speech data corresponding to responsive results generated by the LLM processor, and Voice-over-IP (VoIP) connection data.

7. The system according to claim 1, wherein the sexual stimulation device further comprises a sex toy removable bottom cover coupled to a bottom surface of the sex toy elongated body enclosing the inner cavity, the sex toy removable bottom cover has an audio output screen.

8. The system according to claim 5, wherein the electronic controller circuitry further comprises a voice recognition component and voice generation component.

9. The system according to claim 6, wherein the query digital processor receives auditory data content from a remote content server, the auditory data content includes one or more of the following: the streaming music recording, the sound effects, and the auditory sounds to enhance a mood.

10. The system according to claim 1, wherein the query digital processor communicates with remote servers utilizing a mobile communications device.

11. A method for providing an AI-enabled sex toy having a large language model (LLM) for generating an auditory response to a user input signal, the method comprising:
receiving a user input signal from a microphone;
recognizing a voice input command within the user input signal;
transmitting the voice input command to an LLM processor;
generating a response to the voice input command by the LLM processor utilizing an LLM data model;
generating an auditory response from the response generated within the LLM processor and an LLM data model;
generating a human voice representation of the auditory response; and
outputting the human voice representation of the auditory response utilizing a speaker.

12. The method according to claim 11, wherein the auditory response includes one or more of a following auditory data type: a streaming music recording, sound effects, auditory sounds to enhance a mood, health and wellness advice to provide appropriate and helpful answers to questions, recommend additional activities to improve their intimacy during these activities, synthetic human speech data corresponding to responsive results generated by an LLM processor, and Voice-over-IP (VoIP) connection data.

13. The method according to claim 11, wherein the LLM processor and the LLM data model are hosted within the AI-enabled sex toy.

14. The method according to claim 11, wherein the LLM processor and the LLM data model are hosted in a remote server.

15. The method according to claim 12, wherein the auditory response is received from a remote content server and includes one or more of the following: a streaming music recording, a sound effects, and an auditory sounds to enhance a mood.
